(19) United States
(12) Patent Application Publication
(10) Pub. No.: US 2025/0187263 A1
(43) Pub. Date: Jun. 12, 2025

(54) METHOD FOR MANUFACTURING THREE-DIMENSIONAL SHAPED OBJECT

(71) Applicant: SEIKO EPSON CORPORATION, Tokyo (JP)

(72) Inventors: Kazuya KITADA, Matsumoto (JP); Kazuhide NAKAMURA, Asahi-mura (JP); Eiji OKAMOTO, Matsumoto (JP)

(21) Appl. No.: 18/971,584

(22) Filed: Dec. 6, 2024

(30) Foreign Application Priority Data
Dec. 8, 2023 (JP) 2023-207454

(51) Int. Cl. B29C 64/165; B33Y 10/00; B33Y 70/10

(52) U.S. Cl. CPC B29C 64/165; B33Y 10/00; B33Y 70/10

(57) ABSTRACT

A method for manufacturing a three-dimensional shaped object includes: a first step of shaping a shaped object having a cavity by stacking a plurality of layers by discharging a shaping material toward a stage, in which the first step includes a second step of performing stacking such that each of the layers includes an overlapping portion in contact with a layer immediately below in a stacking direction and a non-overlapping portion not overlapping the layer immediately below and forming a space in the stacking direction, a top surface having two intersecting inclined surfaces is formed in an upper portion of the cavity by the non-overlapping portion, and a rising angle of each of the two inclined surfaces from a surface parallel to the stage is 35° or more and less than 90°.

The present application is based on, and claims priority from JP Application Serial Number 2023-207454, filed Dec. 8, 2023, the disclosure of which is hereby incorporated by reference herein in its entirety.

### BACKGROUND

### 1. Technical Field

The present disclosure relates to a method for manufacturing a three-dimensional shaped object.

### 2. Related Art

JP-A-2016-101731 discloses a three-dimensional shaping device that forms a bridge structure without a support material.

When a three-dimensional shaped object having a cavity is formed without using the support material, a portion located above the cavity may be deformed by gravity.

### SUMMARY

According to a first aspect of the present disclosure, a method for manufacturing a three-dimensional shaped object is provided. The manufacturing method includes a first step of forming a shaped object having a cavity by stacking a plurality of layers by discharging a shaping material toward a stage, in which the first step includes a second step of stacking the plurality of layers such that each of the layers includes an overlapping portion in contact with a layer immediately below in a stacking direction and a non-overlapping portion not overlapping the layer immediately below and forming a space below, a top surface having two intersecting inclined surfaces is formed in an upper portion of the cavity by the non-overlapping portion, and a rising angle of each of the two inclined surfaces from a surface parallel to the stage is 35° or more and less than 90°.

### BRIEF DESCRIPTION OF THE DRAWINGS

FIG. 1 is a diagram illustrating a schematic configuration of a three-dimensional shaping system.

FIG. 2 is a perspective view illustrating a schematic configuration of a screw.

FIG. 3 is a schematic plan view of a barrel.

FIG. 4 is a diagram schematically illustrating a state in which a three-dimensional shaping device forms a shaped object.

FIG. 5 is a diagram illustrating a schematic configuration of an information processing device.

FIG. 6 is a flowchart of shaping processing.

FIG. 7 is a schematic view illustrating a shape of the shaped object.

FIG. 8 is a diagram illustrating top surface formation processing.

FIG. 9 is a diagram illustrating a cross section of the shaped object.

FIG. 10 is a diagram illustrating shaping results of a plurality of samples each having the cavity.

FIG. 11 is an image illustrating the shaping result of Sample 1.

FIG. 12 is an image illustrating the shaping result of Sample 2.

FIG. 13 is an image illustrating the shaping result of Sample 3.

FIG. 14 is an image illustrating the shaping result of Sample 4.

FIG. 15 is an image illustrating the shaping result of Sample 5.

FIG. 16 is an image illustrating the shaping result of Sample 6.

FIG. 17 is an image illustrating the shaping result of Sample 7.

FIG. 18 is an image illustrating the shaping result of Sample 8.

FIG. 19 is an image illustrating the shaping result of Sample 9.

FIG. 20 is an image illustrating the shaping result of Sample 10.

FIG. 21 is an image illustrating the shaping result of Sample 11.

FIG. 22 is an image illustrating the shaping result of Sample 12.

FIG. 23 is an image illustrating the shaping result of Sample 13.

FIG. 24 is a view illustrating another shape of the cavity.

FIG. 25 is a diagram illustrating a cross section of the shaped object.

### DESCRIPTION OF EMBODIMENTS

### A. First Embodiment

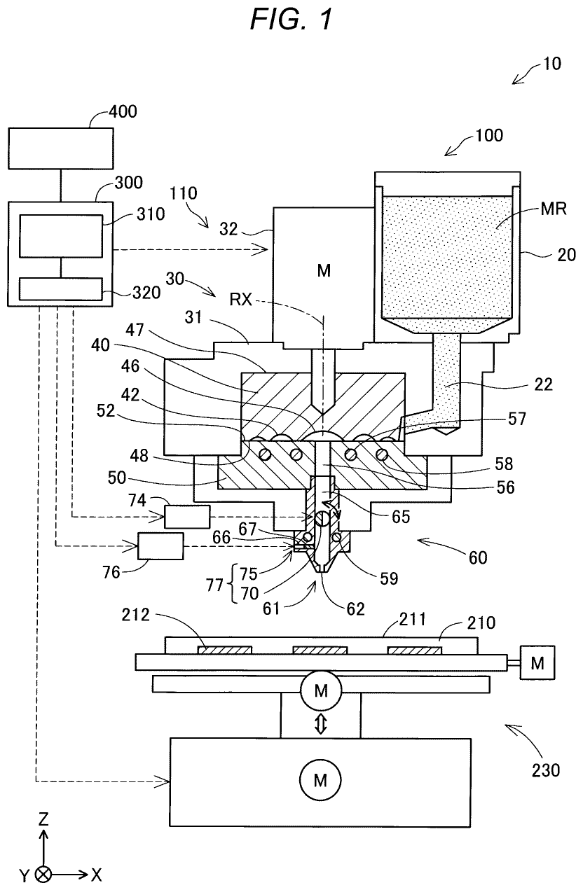

FIG. 1 is a diagram illustrating a schematic configuration of a three-dimensional shaping system 10 in a first embodiment. FIG. 1 illustrates arrows indicating X, Y, and Z directions orthogonal to one another. The X direction and the Y direction are directions parallel to a horizontal plane. The Z direction is a direction along a vertically upward direction. The arrows indicating the X, Y, and Z directions are illustrated as appropriate in other drawings as well such that illustrated directions correspond to those in FIG. 1. In the following description, when a direction is specified, a direction indicated by an arrow in the drawings is represented as “+” and a direction opposite to the direction is represented as “−”, and the positive and negative signs are also used in direction notation. In the following description, a +Z direction is also referred to as “upper”, and a −Z direction is also referred to as “lower”.

The three-dimensional shaping system 10 includes a three-dimensional shaping device 100 and an information processing device 400. The three-dimensional shaping device 100 according to the embodiment is a device that forms a shaped object by a material extrusion method. The three-dimensional shaping device 100 includes a control unit 300 for controlling units of the three-dimensional shaping device 100. The control unit 300 and the information processing device 400 are communicably connected.

The three-dimensional shaping device 100 includes a head unit 110 that generates and discharges a shaping material, a stage 210 for shaping serving as a base of the shaped object, and a movement mechanism 230 that controls a discharge position of the shaping material.

The head unit 110 discharges the shaping material obtained by plasticizing a material in a solid state onto the stage 210 under the control of the control unit 300. The head unit 110 includes a material supply unit 20 which is a supply source of a raw material before being converted into the shaping material, a plasticizing unit 30 which converts the raw material into the shaping material, and a discharge unit 60 which discharges the shaping material.

The material supply unit 20 supplies a raw material MR to the plasticizing unit 30. The material supply unit 20 is implemented by, for example, a hopper that accommodates the raw material MR. The material supply unit 20 is coupled to the plasticizing unit 30 via a communication path 22. The raw material MR is put into the material supply unit 20 in a form of powder or pellets. Examples of the raw material MR include thermoplastic resin materials such as acrylonitrile-butadiene-styrene (ABS), polyether ether ketone (PEEK), and polypropylene (PP), or a material containing metal particles or ceramics and binders is used.

The plasticizing unit 30 plasticizes the raw material MR supplied from the material supply unit 20 to generate a paste-shaped shaping material exhibiting fluidity and guides the shaping material to the discharge unit 60. In the embodiment, the term “plasticize” is a concept including melting and means changing from a solid state to a state having fluidity. Specifically, in a case of a material in which glass transition occurs, the term “plasticize” refers to setting a temperature of the material to a temperature equal to or higher than a glass transition point. In a case of a material in which the glass transition does not occur, the term “plasticize” refers to setting a temperature of the material to a temperature equal to or higher than a melting point.

The plasticizing unit 30 includes a screw case 31, a drive motor 32, a screw 40, and a barrel 50. The screw 40 is also referred to as a flat screw, a rotor, or a scroll. The barrel 50 is also referred to as a screw facing portion.

The screw 40 is housed in the screw case 31. An upper surface 47 of the screw 40 is coupled to the drive motor 32, and the screw 40 rotates in the screw case 31 by a rotational drive force generated by the drive motor 32. The drive motor 32 is driven under the control of the control unit 300. The screw 40 may be driven by the drive motor 32 via a speed reducer.

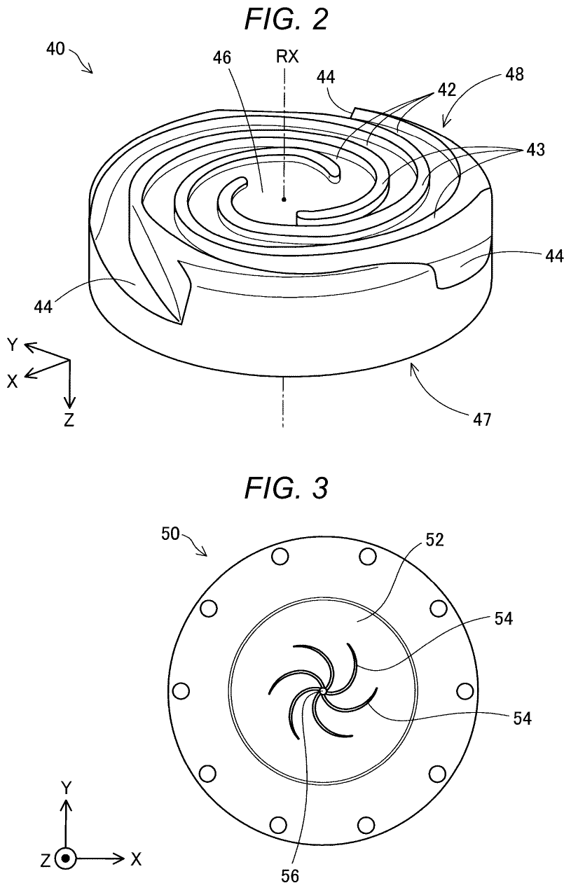

FIG. 2 is a perspective view illustrating a schematic configuration on a lower surface 48 side of the screw 40. To facilitate understanding of the technique, the screw 40 illustrated in FIG. 2 is illustrated in a state in which a positional relationship between the upper surface 47 and the lower surface 48 illustrated in FIG. 1 is reversed in a vertical direction. The screw 40 has a substantially cylindrical shape whose length in an axial direction that is a direction along a central axis thereof is smaller than a length in a direction perpendicular to the axial direction. The screw 40 is disposed such that a rotation axis RX that is a rotation center thereof is parallel to the Z direction.

Grooves 42 each having a vortex shape are formed in the lower surface 48, which is a surface crossing the rotation axis RX, of the screw 40. The communication path 22 of the material supply unit 20 communicates with the grooves 42 from a side surface of the screw 40. In the embodiment, three grooves 42 are formed being separated by ridge portions 43. The number of grooves 42 is not limited to three and may be one or two or more. The grooves 42 do not necessarily have a vortex shape and may have a spiral shape or an involute curve shape, or may have a shape extending arcuately from a central part 46 toward an outer periphery.

As illustrated in FIG. 1, the lower surface 48 of the screw 40 faces an upper surface 52 of the barrel 50. A space is formed between the grooves 42 in the lower surface 48 of the screw 40 and the upper surface 52 of the barrel 50. The raw material MR is supplied from the material supply unit 20 to the space between the screw 40 and the barrel 50 through material inlets 44 illustrated in FIG. 2.

A first barrel heater 57 and a second barrel heater 58 are embedded in the barrel 50 as a heater for heating the raw material MR supplied into the grooves 42 of the rotating screw 40. The first barrel heater 57 heats an inner portion of the barrel 50. The second barrel heater 58 heats an outer portion of the barrel 50. A temperature of the first barrel heater 57 and a temperature of the second barrel heater 58 are controlled by the control unit 300. A communication hole 56 is provided at a center of the barrel 50.

FIG. 3 is a schematic plan view illustrating an upper surface 52 side of the barrel 50. A plurality of guide grooves 54 coupled to the communication hole 56 and extending in a vortex shape from the communication hole 56 toward an outer periphery are formed in the upper surface 52 of the barrel 50. One end of the guide groove 54 may not be coupled to the communication hole 56. The guide grooves 54 may be omitted.

The raw material MR supplied into the grooves 42 of the screw 40 flows along the grooves 42 due to the rotation of the screw 40 while being plasticized in the grooves 42, and is guided to the central part 46 of the screw 40 as the shaping material. The paste-shaped shaping material exhibiting fluidity, which flows into the central part 46, is supplied to the discharge unit 60 via the communication hole 56 provided at the center of the barrel 50. In the shaping material, not all types of substances forming the shaping material may be plasticized. The shaping material may be converted into a state having fluidity as a whole by plasticizing at least a part of the types of substances forming the shaping material.

The discharge unit 60 illustrated in FIG. 1 includes a nozzle 61 that discharges the shaping material, a flow path 65 of the shaping material that is formed between the screw 40 and a nozzle opening 62, and a discharge control unit 77 that controls the discharge of the shaping material.

The nozzle 61 is coupled to the communication hole 56 of the barrel 50 through the flow path 65. Through the nozzle 61, the shaping material generated in the plasticizing unit 30 is discharged from the nozzle opening 62 at a tip end toward the stage 210. A nozzle heater 59 for preventing a decrease in temperature of the shaping material is embedded in the nozzle 61. A temperature of the nozzle heater 59 is controlled by the control unit 300.

The discharge control unit 77 includes a discharge amount adjustment mechanism 70 that opens and closes the flow path 65 and a suction mechanism 75 that suctions and temporarily stores the shaping material.

The discharge amount adjustment mechanism 70 is provided in the flow path 65 and changes an opening degree of the flow path 65 by rotating in the flow path 65. In the embodiment, the discharge amount adjustment mechanism 70 is implemented by a valve. The discharge amount adjustment mechanism 70 is driven by a first drive unit 74 under the control of the control unit 300. The first drive unit 74 is implemented by, for example, a stepping motor. The control unit 300 can adjust a flow rate of the shaping material flowing from the plasticizing unit 30 to the nozzle 61, that is, a discharge amount of the shaping material discharged from the nozzle 61 by controlling a rotation angle of the valve using the first drive unit 74. The discharge amount adjustment mechanism 70 can adjust the discharge amount of the shaping material and can control ON and OFF of an outflow of the shaping material.

The suction mechanism 75 includes a branch flow path 66 coupled to the flow path 65 and a plunger 67 disposed in the branch flow path 66. The branch flow path 66 is coupled to the flow path 65 between the discharge amount adjustment mechanism 70 and the nozzle opening 62. Hereinafter, moving the plunger 67 in the branch flow path 66 away from the flow path 65 will be referred to as “pulling the plunger 67”, and moving the plunger 67 closer to the flow path 65 will be referred to as “pushing the plunger 67”. The plunger 67 of the suction mechanism 75 is driven by a second drive unit 76 under the control of the control unit 300. The second drive unit 76 is implemented, for example, by a stepping motor or a rack-and-pinion mechanism that converts a rotational force generated by the stepping motor into a translational motion of the plunger 67.

The control unit 300 controls the suction mechanism 75 to temporarily suction the shaping material in the flow path 65 into the branch flow path 66 by pulling the plunger 67 when the discharge of the shaping material from the nozzle 61 is stopped. In this way, it is possible to prevent an elongating phenomenon in which the shaping material hangs down like a string from the nozzle opening 62. When the discharge of the shaping material from the nozzle 61 is restarted, the control unit 300 adjusts the discharge amount of the shaping material fed from the nozzle 61 to be constant by pulling the plunger 67 to suction the shaping material in the flow path 65 or pushing the plunger 67 to feed the shaping material into the flow path 65. In this way, a line width of the shaping material can be kept constant when the discharge is restarted.

The stage 210 is disposed at a position facing the nozzle opening 62 of the nozzle 61. In the first embodiment, a shaping surface 211 of the stage 210 facing the nozzle opening 62 of the nozzle 61 is parallel to the X and Y directions, that is, a horizontal direction. The stage 210 includes a stage heater 212 for preventing the shaping material discharged onto the stage 210 from being suddenly cooled. The stage heater 212 is controlled by the control unit 300.

The movement mechanism 230 changes a relative position between the stage 210 and the nozzle 61 under the control of the control unit 300. In the embodiment, a position of the nozzle 61 is fixed, and the movement mechanism 230 moves the stage 210. The movement mechanism 230 is implemented by a three-axis positioner that moves the stage 210 in three axial directions including the X, Y, and Z directions by driving forces of three motors. In the present specification, unless noted otherwise, a movement of the nozzle 61 means moving the nozzle 61 or the discharge unit 60 with respect to the stage 210.

In another embodiment, a configuration in which the movement mechanism 230 moves the nozzle 61 with respect to the stage 210 in a state in which a position of the stage 210 is fixed may be adopted instead of a configuration in which the stage 210 is moved by the movement mechanism 230. In addition, a configuration in which the stage 210 is moved in the Z direction by the movement mechanism 230 and the nozzle 61 is moved in the X and Y directions, or a configuration in which the stage 210 is moved in the X and Y directions by the movement mechanism 230 and the nozzle 61 is moved in the Z direction may be adopted. With such configurations, a relative positional relationship between the nozzle 61 and the stage 210 can be changed.

The control unit 300 is a control device that controls operations of the entire three-dimensional shaping device 100. The control unit 300 is implemented by a computer including one or more processors 310, a storage device 320 including a main storage device and an auxiliary storage device, and an input and output interface for receiving and outputting a signal from and to an outside. The processor 310 executes a program stored in the storage device 320, thereby controlling the plasticizing unit 30 and the movement mechanism 230 according to shaping data acquired from the information processing device 400 to form a shaped object on the stage 210. The control unit 300 may be implemented by combining circuits instead of the computer.

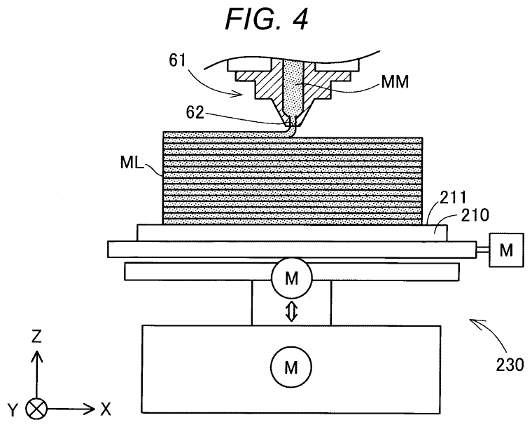

FIG. 4 is a diagram schematically illustrating a state in which the three-dimensional shaping device 100 forms the shaped object. As described above, the raw material MR in a solid state is plasticized to generate a shaping material MM in the three-dimensional shaping device 100. The control unit 300 causes the nozzle 61 to discharge the shaping material MM while changing the position of the nozzle 61 with respect to the stage 210 in a direction along the shaping surface 211 of the stage 210, maintaining the distance between the shaping surface 211 of the stage 210 and the nozzle 61. The shaping material MM discharged from the nozzle 61 is continuously deposited in a movement direction of the nozzle 61.

The control unit 300 forms layers ML by repeating the movement of the nozzle 61. After forming one layer ML, the control unit 300 moves the position of the nozzle 61 with respect to the stage 210 by a pre-specified stacking pitch in the Z direction, which is a stacking direction. Then, the control unit 310 further stacks a layer ML on the layers ML that are formed so far to form the shaped object.

For example, the control unit 300 may temporarily interrupt the discharge of the shaping material from the nozzle 61 when the nozzle 61 moves in the Z direction in a case of completing one layer ML or when there are a plurality of independent shaping regions in each layer. In this case, the control unit 300 closes the flow path 65 by the discharge amount adjustment mechanism 70, stops the discharge of the shaping material MM from the nozzle opening 62, and temporarily suctions the shaping material in the nozzle 61 by the suction mechanism 75. After changing the position of the nozzle 61, the control unit 300 discharges the shaping material in the suction mechanism 75 and opens the flow path 65 by the discharge amount adjustment mechanism 70, thereby restarting the deposition of the shaping material MM from the changed position of the nozzle 61.

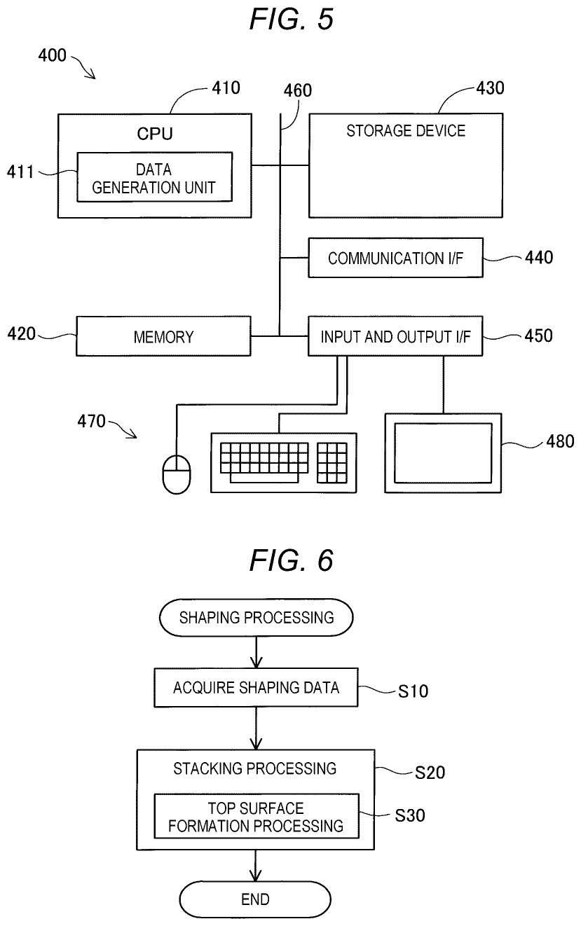

FIG. 5 is a diagram illustrating a schematic configuration of the information processing device 400. The information processing device 400 is implemented as a computer in which a CPU 410, a memory 420, a storage device 430, a communication interface 440, and an input and output interface 450 are coupled by a bus 460. An input device 470 such as a keyboard and a mouse and a display unit 480 such as a liquid crystal display are coupled to the input and output interface 450. The information processing device 400 is coupled to the control unit 300 of the three-dimensional shaping device 100 via the communication interface 440.

The CPU 410 functions as a data generation unit 411 by executing a program stored in the storage device 430. The data generation unit 411 generates the

shaping data. The shaping data is data representing information related to a movement path of the nozzle 61 with respect to the stage 210, an amount of the shaping material discharged from the nozzle 61, and a rotation speed of the screw 40. The data generation unit 411 reads shape data representing a shape of the three-dimensional shaped object formed using three-dimensional CAD software or three-dimensional CG software, and divides the shape of the three-dimensional shaped object into layers each having a predetermined thickness. The data generation unit 411 determines the movement path of the nozzle 61 and the amount of the shaping material to fill each of the layers thus divided with the shaping material, thereby generating the shaping data. The nozzle 61 moves along the movement path specified by the shaping data, and the shaping material of an amount specified by the shaping data is discharged, thereby forming a path having a predetermined line width on the stage 210.

FIG. 6 is a flowchart of shaping processing for implementing a method for manufacturing a three-dimensional shaped object. The shaping processing is executed by the control unit 300 of the three-dimensional shaping device 100. In step S10, the control unit 300 acquires the shaping data generated by the information processing device 400.

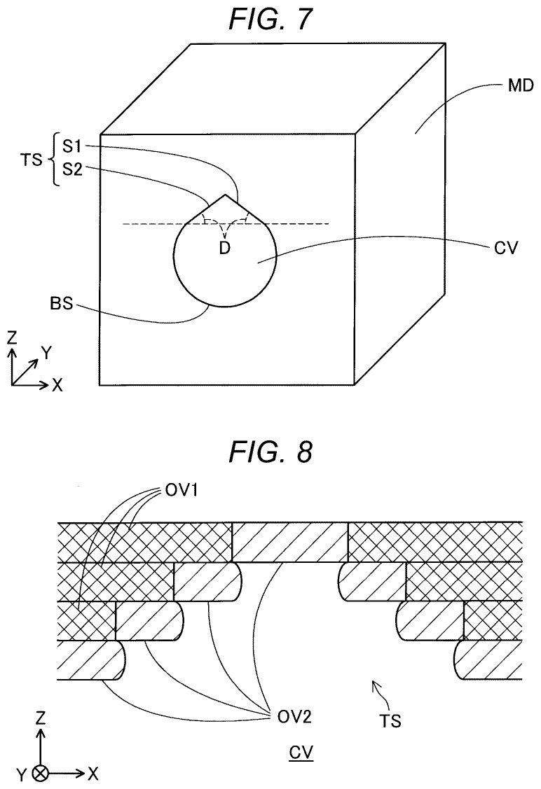

FIG. 7 is a schematic view illustrating a shape of a shaped object MD formed in the embodiment. In the embodiment, a rectangular parallelepiped shaped object MD having a tubular cavity CV along the Y direction at centers in the X direction and the Z direction is formed. For example, the cavity CV is used as a pipe after the shaped object MD is completed, and a fluid flows inside. The cavity CV has a shape in which an upper portion and a lower portion are different. A top surface TS having two intersecting inclined surfaces S1 and S2 is formed in the upper portion of the cavity CV. A rising angle D of each of the two inclined surfaces S1 and S2 is less than 90°. The rising angle D is an angle at which the inclined surfaces S1 and S2 rise from a plane parallel to the stage 210. The rising angle D of the inclined surface S1 and the rising angle D of the inclined surface S2 may be the same angle or different angles. A semicircular bottom surface BS is formed in the lower portion of the cavity CV. When the bottom surface BS in the lower portion of the cavity CV is semicircular, a flow path resistance of the cavity CV can be reduced when the fluid flows in the cavity CV after the shaped object MD is completed. Such an effect is remarkable when a liquid serving as the fluid flows through the lower portion of the cavity CV. The shaping data acquired from the information processing device 400 is data for forming the shaped object MD illustrated in FIG. 7 for each layer.

In step S20 in FIG. 6, the control unit 300 executes stacking processing. In the stacking processing, the control unit 300 controls the plasticizing unit 30, the discharge control unit 77, and the movement mechanism 230 according to the shaping data acquired in step S10 to discharge the shaping material toward the stage 210, thereby stacking a plurality of layers to form the shaped object MD having the cavity CV. Step S20 is also referred to as a first step.

The stacking processing in step S20 includes top surface formation processing in step S30. The top surface formation processing is processing for forming the top surface TS illustrated in FIG. 7. Step S30 is also referred to as a second step.

FIG. 8 is a diagram illustrating the top surface formation processing. FIG. 8 is an enlarged view of a plurality of layers forming an uppermost portion of the top surface TS. In the top surface formation processing, the control unit 300 controls the plasticizing unit 30, the discharge control unit 77, and the movement mechanism 230 according to the shaping data to stack the plurality of layers such that each of the layers has an overlapping portion OV1 in contact with a layer immediately below in the stacking direction and a non-overlapping portion OV2 that does not overlap with the layer immediately below and forms a space below. In FIG. 8, the overlapping portion OV1 is cross-hatched, and the non-overlapping portion OV2 is single-hatched. By forming the non-overlapping portion OV2 in each of the layers, the control unit 300 forms the top surface TS having the two intersecting inclined surfaces S1 and S2 in the upper portion of the cavity CV.

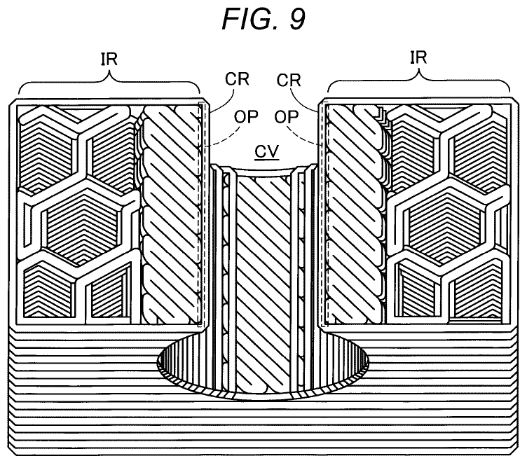

FIG. 9 is a diagram illustrating a cross section of the shaped object MD. Each of the layers for forming the cavity CV includes an outermost peripheral region CR and an inner region IR in contact with an inside of the outermost peripheral region CR. The outermost peripheral region CR is a region for shaping the outermost periphery of the shaped object MD in each layer. In the example illustrated in FIG. 9, the inner region IR includes a zigzag pattern having an infill ratio of 100% and a honeycomb pattern having an infill ratio of 25%. The zigzag pattern is formed in a region close to the cavity CV in the inner region IR, and the honeycomb pattern is formed in a region far from the cavity CV in the inner region IR. The entire inner region IR may be shaped by a single pattern having an infill ratio of 100%. The pattern for shaping the inner region IR is not limited to the zigzag pattern or the honeycomb pattern. Another pattern such as a concentric circle pattern or a triangle pattern may be used.

In step S30, the control unit 300 shapes each layer such that an outermost peripheral path for shaping the outermost peripheral region CR and an inner path for shaping the inner region IR at least partially overlap. In this way, the outermost peripheral region CR can be prevented from peeling off from the inner region IR.

An amount by which the inner path overlaps with respect to a line width of the outermost peripheral path is referred to as an overlap amount. In FIG. 9, a range in which the overlap occurs is illustrated as an overlap portion OP. In step S30, the control unit 300 stacks each layer such that the outermost peripheral path and the inner path overlap in at least a part of the non-overlapping portion OV2 forming the top surface TS. That is, in FIG. 8, each layer is shaped and the top surface TS is formed such that the overlap portion OP is located in the single-hatched portion indicating the non-overlapping portion OV2. In this way, a strength of the top surface TS can be increased.

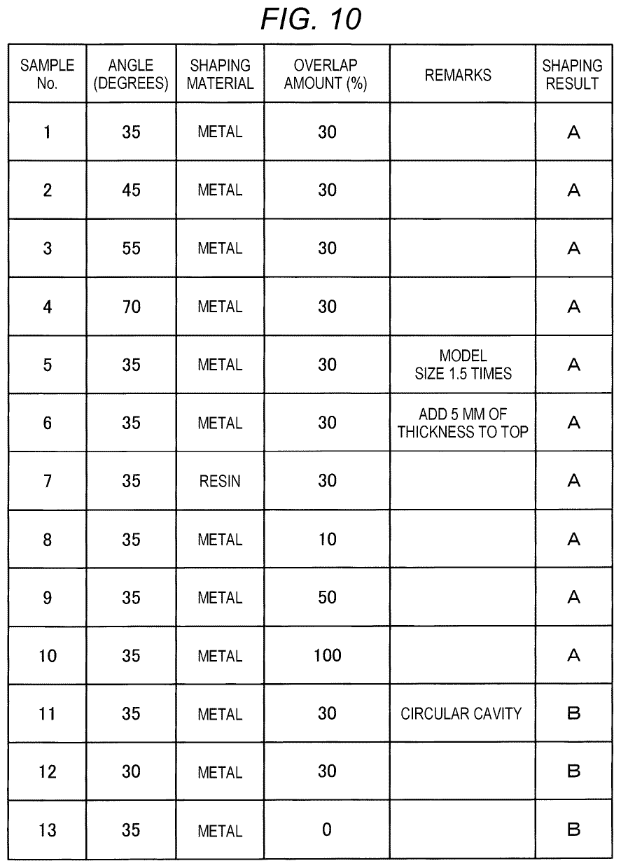

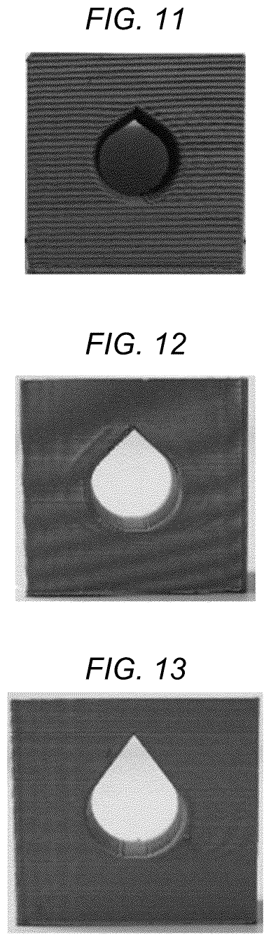

FIG. 10 is a diagram illustrating shaping results of a plurality of samples each having the cavity CV. FIGS. 11 to 23 are images illustrating the shaping results of the samples, respectively. In the embodiment, samples of 13 types of shaped objects MD having different rising angles D of the inclined surfaces S1 and S2, different shaping materials, and different overlap amounts, were shaped, and appearance shapes of the cavity CV were visually confirmed to perform evaluation. In FIG. 10, an evaluation result is indicated as “A” or “B”. Evaluation A indicates that the cavity CV was satisfactorily shaped, and Evaluation B indicates that the cavity CV was not satisfactorily shaped. Hereinafter, each sample will be described in detail.

As a shaping material of Sample 1, a metal material containing metal particles of SUS630, 7 parts by mass of a fluidity component, an adhesive component, a shaping component, and a plasticizer which constitute a binder was used. As shaping conditions of Sample 1, a diameter of the nozzle opening 62 was 0.4 mm, the line width of the path was 0.5 mm, the stacking pitch was 0.2 mm, a material extrusion speed from the nozzle 61 was 50 mm/sec, the temperature of the first barrel heater 57 was 90° C., the temperature of the second barrel heater 58 was 80° C., the temperature of the nozzle heater 59 was 125° C., and the overlap amount was 30%. A shape of Sample 1 was the shape of the shaped object MD illustrated in FIG. 7. Specifically, the shaped object MD was formed in which a substantially circular cavity CV having a diameter of 10 mm was provided at a center of a cube with sides of 25 mm, and the rising angles D of the inclined surfaces S1 and S2 forming the top surface TS of the cavity CV were set to 35°. As a result, as illustrated in FIG. 11, a cavity CV having a good shape was formed without forming a support structure in the cavity CV.

A shaping material and shaping conditions of Sample 2 were the same as those of Sample 1. Regarding a shape of Sample 2, only the rising angles D of the inclined surfaces S1 and S2 were made different from those of Sample 1, and were set to 45°. As a result, as illustrated in FIG. 12, a cavity CV having a good shape was formed without forming a support structure in the cavity CV.

A shaping material and shaping conditions of Sample 3 were the same as those of Sample 1. Regarding a shape of Sample 3, only the rising angles D of the inclined surfaces S1 and S2 were made different from that of Sample 1, and were set to 55°. As a result, as illustrated in FIG. 13, a cavity CV having a good shape was formed without forming a support structure in the cavity CV.

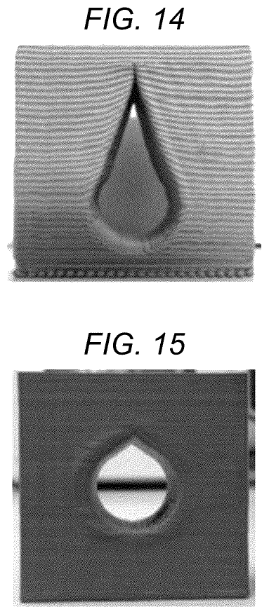

A shaping material and shaping conditions of Sample 4 were the same as those of Sample 1. Regarding a shape of Sample 4, only the rising angles D of the inclined surfaces S1 and S2 were made different from that of Sample 1, and were set to 70°. As a result, as illustrated in FIG. 14, a cavity CV having a good shape was formed without forming a support structure in the cavity CV.

A shaping material and shaping conditions of Sample 5 were the same as those of Sample 1. Sample 5 was 1.5 times the size of Sample 1. Specifically, the shaped object MD was formed in which a substantially circular cavity CV having a diameter of 15 mm was provided at a center of a cube with sides of 37.5 mm, and the rising angles D of the inclined surfaces S1 and S2 forming the top surface TS of the cavity CV were set to 35°. As a result, as illustrated in FIG. 15, a cavity CV having a good shape was formed without forming a support structure in the cavity CV.

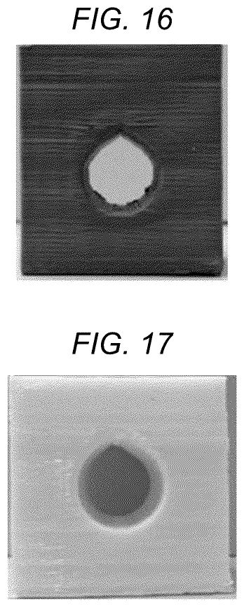

A shaping material and shaping conditions of Sample 6 were the same as those of Sample 1. Sample 6 had a shape in which sizes in the X direction and the Y direction were set to 25 mm which is the same as that of Sample 1, and a size in the Z direction was set to 30 mm which is different from that of Sample 1. A shape of the cavity CV is the same as that of Sample 1. In Sample 6, a height of the cavity CV from the stage 210 was not changed from that of Sample 1, and the shaped object MD was formed such that a thickness of 5 mm was applied to the upper portion of the cavity CV. As a result, as illustrated in FIG. 16, a cavity CV having a good shape was formed without forming a support structure in the cavity CV.

A shaping material of Sample 7 is different from that of Sample 1 and is a PLA resin containing no metal powder. As shaping conditions thereof, a temperature of the first barrel heater 57 was 240° C., a temperature of the second barrel heater 58 was 230° C., a temperature of the nozzle heater 59 was 205° C., and the other conditions were the same as those of Sample 1. A shape of Sample 7 is the same as that of Sample 1. As a result, as illustrated in FIG. 17, a cavity CV having a good shape was formed without forming a support structure in the cavity CV.

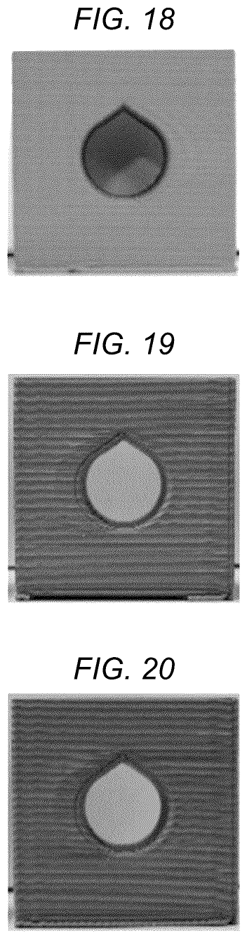

A shaping material Sample 8 was the same as that of Sample 1. In Sample 8, an overlap amount was 10%, and the other shaping conditions were the same as those of Sample 1. A shape of Sample 8 is the same as that of Sample 1. As a result, as illustrated in FIG. 18, a cavity CV having a good shape was formed without forming a support structure in the cavity CV.

A shaping material Sample 9 was the same as that of Sample 1. In Sample 9, an overlap amount was 50%, and the other shaping conditions were the same as those of Sample 1. A shape of Sample 9 is the same as that of Sample 1. As a result, as illustrated in FIG. 19, a cavity CV having a good shape was formed without forming a support structure in the cavity CV.

A shaping material Sample 10 was the same as that of Sample 1. In Sample 10, an overlap amount was 100%, and the other shaping conditions were the same as those of Sample 1. A shape of Sample 10 is the same as that of Sample 1. As a result, as illustrated in FIG. 20 a cavity CV having a good shape was formed without forming a support structure in the cavity CV.

A shaping material and shaping conditions of Sample 11 were the same as those of Sample 1. In Sample 11, a shape of the cavity CV was a circle having a diameter of 15 mm, and the two inclined surfaces S1 and S2 were not formed. As a result, as illustrated in FIG. 21, the material dripped from the top surface TS of the cavity CV, and the cavity CV cannot be formed well.

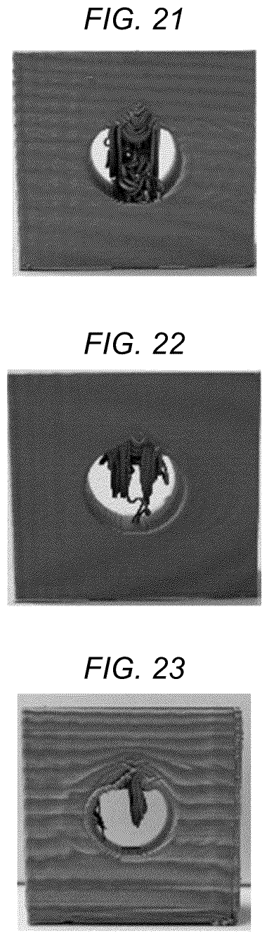

A shaping material and shaping conditions of Sample 12 were the same as those of Sample 1. In Sample 12, only the rising angles D of the inclined surfaces S1 and S2 were made different from those of Sample 1, and were set to 30°. As a result, as illustrated in FIG. 22, the material dropped from the upper surface of the cavity CV, and the cavity CV cannot be formed well.

A shaping material and shaping conditions of Sample 13 were the same as those of Sample 1. In Sample 13, only the overlap amount was made different from that of Sample 1, and was set to 0%. As a result, as illustrated in FIG. 23, the material dripped from the top surface TS of the cavity CV, and the cavity CV cannot be formed well.

As described above, in Sample 11 in which the rising angles D of the inclined surfaces S1 and S2 forming the top surface TS of the cavity CV are 30°, the cavity CV is not formed well, and in Sample 1 in which the rising angles D are 35°, the cavity CV is formed well. Therefore, to prevent a portion of the shaped object MD located above the cavity CV from being deformed due to gravity and to form the cavity CV without shaping the support structure, the rising angle D is preferably 35° or more. To form the top surface TS by the two inclined surfaces S1 and S2, the rising angle D needs to be less than 90°. Therefore, the rising angles D of the inclined surfaces S1 and S2 are preferably 35° or more and less than 90°. Even in Samples 2 to 4 in which the rising angle D is 45°, 55°, and 70°, the cavity CV can be formed well. Therefore, to prevent stress concentration in an intersection portion of the inclined surfaces S1 and S2, the rising angle D is preferably 35° or more and 70° or less, more preferably 35° or more and 55° or less.

In Sample 5, the size of the shaped object MD is 1.5 times that of Sample 1, and in Sample 6, the thickness of the shaped object above the cavity CV is increased by 5 mm. In Sample 7, a resin material having a weight lighter than that of the metal is used. Even in Samples 5, 6, and 7, the cavity CV could be formed well by setting the rising angles D of the inclined surfaces S1 and S2 to 35°. Therefore, the rising angle D is preferably 35° or more regardless of the size and weight of the shaped object MD and the thickness of the shaped object above the cavity CV. In particular, when a metal material is used as the shaping material, since the weight applied to the top surface TS increases, the effect of defining the rising angles D of the inclined surfaces S1 and S2 as described above is significant.

In Sample 8 in which the overlap amount was 10%, the cavity CV was formed well, and in Sample 13 in which the overlap amount was 0%, the cavity CV could not be formed well. Therefore, it is preferable that each layer is shaped such that the outermost peripheral path for shaping the outermost peripheral region CR and the inner path for shaping the inner region IR at least partially overlap to form the shaped object MD. In particular, as can be understood from the result of Sample 8, it is preferable that the overlap amount by which the inner path overlaps the outermost peripheral path is 10% or more with respect to the line width of the outermost peripheral path. In Sample 8, Sample 1, Sample 9, and Sample 10 having overlap amounts of 10%, 30%, 50%, and 100%, respectively, the cavity CV is formed well. However, when the overlap amount is 100%, the path may overlap the overlap portion by the shaping conditions, which may reduce shaping accuracy. Therefore, an upper limit of the overlap amount is preferably 50%. That is, the overlap amount is preferably 10% or more and 50% or less.

### B. Other Embodiments

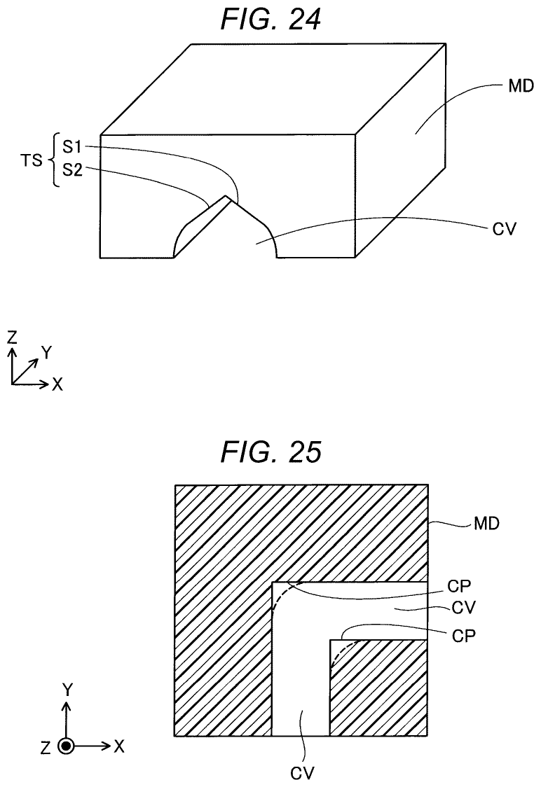

(B1) FIG. 24 is a view illustrating another shape of the cavity CV. In the above-described embodiment, the cavity CV is formed at the center of the shaped object MD. In contrast, as illustrated in FIG. 24, the cavity CV may be formed to have an opening downward at a bottom of the shaped object MD.

(B2) FIG. 25 is a diagram illustrating another cross section of the shaped object MD. The cavity CV described in the above-described embodiment extends linearly in the shaped object MD. In contrast, in the shaped object MD, as illustrated in FIG. 25, a plurality of cavities CV may be formed to intersect or be connected with each other. In this case, the shaped object MD is preferably formed such that corner portions CP of a portion at which the plurality of cavities CV intersect, or corner portions CP of a portion at which the plurality of cavities CV are connected are chamfered, such as by R-chamfering, as indicated by broken lines in FIG. 25. By chamfering the corner portions CP, the flow path resistance of the cavity CV can be reduced when the fluid flows into the cavity CV.

(B3) In the above-described embodiment, each of the layers for forming the cavity CV includes the outermost peripheral region CR and the inner region IR in contact with the inside of the outermost peripheral region CR. In contrast, each of the layers for forming the cavity CV may not include the outermost peripheral region CR. That is, each layer may include only the inner region IR. In this case, since the outermost peripheral region CR is not present, the overlap portion OP at which the outermost peripheral path for shaping the outermost peripheral region CR and the inner path for shaping the inner region IR overlap is not formed. Therefore, the outermost peripheral path and the inner path do not overlap in the non-overlapping portion OV2 forming the top surface TS.

(B4) In the above-described embodiment, the inner region IR in contact with the inside of the outermost peripheral region CR may include an intermediate region of one round or a plurality of rounds that surrounds the entire inner region IR to be in contact with the outermost peripheral region CR. The outermost peripheral region CR and the intermediate region overlap, thereby forming the overlap portion OP. In this case, the outermost peripheral region CR and the intermediate region in contact with the inside of the outermost peripheral region CR can be referred to as an outer shell region, and the inner region IR located inside the outer shell region can be referred to as an infill region.

(B5) In the above-described embodiment, the plasticizing unit 30 plasticizes the material by the flat screw. In contrast, the plasticizing unit 30 may plasticize the material by, for example, rotating an in-line screw. In addition, the plasticizing unit 30 may plasticize a filament material by a heater.

(B6) In the above-described embodiment, the three-dimensional shaping device 100 can form a three-dimensional shaped object using various materials such as a thermoplastic material, a metal material, and a ceramic material as main materials. Here, the term “main material” means a material serving as a center for forming the shape of the three-dimensional shaped object, and means a material having a content of 50% by mass or more in the three-dimensional shaped object. The shaping material described above includes a material obtained by melting the main material alone and a material obtained by melting the main material and a part of contained components into a paste shape.

When a thermoplastic material is used as the main material, the plasticizing unit 30 plasticizes this material to generate the shaping material.

As the thermoplastic material, for example, the following thermoplastic resin material can be used.

### Examples of Thermoplastic Resin Material

Polypropylene resin (PP), polyethylene resin (PE), polyacetal resin (POM), polyvinyl chloride resin (PVC), polyamide resin (PA), acrylonitrile-butadiene-styrene resin (ABS), polylactic acid resin (PLA), polyphenylene sulfide resin (PPS), polyether ether ketone (PEEK), polycarbonate (PC), general-purpose engineering plastics such as modified polyphenylene ether, polybutylene terephthalate, and polyethylene terephthalate, and engineering plastics such as polysulfone, polyethersulfone, polyphenylene sulfide, polyarylate, polyimide, polyamideimide, polyetherimide, and polyetheretherketone.

In addition to a pigment, a metal, and a ceramic, an addition agent such as a wax, a flame retardant, an antioxidant, and a heat stabilizer may be mixed into the thermoplastic material. In the plasticizing unit 30, the thermoplastic material is plasticized and converted into a molten state by rotation of the screw 40 and heating of the heater. The shaping material generated by melting the thermoplastic material is discharged from the nozzle 61 and then cured by a decrease in temperature.

It is desirable that the thermoplastic material is discharged from the nozzle 61 in a completely molten state by being heated to a glass transition point or larger. For example, it is desirable that the ABS resin has a glass transition point of about 120° C. and is about 200° C. when being discharged from the nozzle 61.

In the three-dimensional shaping device 100, for example, the following metal material may be used as the main material instead of the thermoplastic material described above. In this case, it is desirable that a powder material obtained by powdering the following metal material is mixed with a component that melts when generating the shaping material, followed by being fed into the plasticizing unit 30 as the raw material.

### Examples of Metal Material

A single metal such as magnesium (Mg), iron (Fe), cobalt (Co), chromium (Cr), aluminum (Al), titanium (Ti), copper (Cu), or nickel (Ni), or an alloy containing two or more of these metals.

### Examples of Alloy

Maraging steel, stainless steel, cobalt chrome molybdenum, titanium alloy, nickel alloy, aluminum alloy, cobalt alloy, and cobalt chrome alloy.

In the three-dimensional shaping device 100, a ceramic material may be used as the main material instead of the metal material described above. As the ceramic material, oxide ceramic such as silicon dioxide, titanium dioxide, aluminum oxide, and zirconium oxide, and non-oxide ceramic such as aluminum nitride may be used. When the metal material or the ceramic material as described above is used as the main material, the shaping material disposed on the stage 210 may be cured by sintering using laser irradiation, warm air, or the like.

A powder material of the metal material or the ceramic material fed to the material supply unit 20 as the raw material may be a mixed material obtained by mixing a plurality of types of powder of the single metal, powder of the alloy, and powder of the ceramic material. The powder material of the metal material or the ceramic material may be coated with, for example, the thermoplastic resin exemplified above or another thermoplastic resin. In this case, in the plasticizing unit 30, the thermoplastic resin may be melted to exhibit fluidity.

For example, the following solvent may be added to the powder material of the metal material or the ceramic material fed into the material supply unit 20 as the raw material. The solvent can be used alone or in combination of two or more selected from the following.

### Examples of Solvent

Water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetate (for example, tetrabutylammonium acetate); and ionic liquids such as butyl carbitol acetate.

In addition, for example, the following binder may be added to the powder material of the metal material or the ceramic material fed into the material supply unit 20 as the raw material.

### Examples of Binder

Various resins such as polyethylene, polypropylene, polyolefin, acrylic resin, styrene resin, polyvinyl chloride, polyamide, polyester, polyether, polyvinyl alcohol, polyvinylpyrrolidone, various waxes, paraffin, higher fatty acids, higher alcohols, and higher fatty acid esters.

### C. Other Aspects

The present disclosure is not limited to the embodiments described above and may be achieved with various configurations without departing from the intent of the present disclosure. For example, to solve some or all of the problems described above, or to achieve some or all of the effects described above, technical features of the embodiments that correspond to the technical features in each of the following aspects can be replaced or combined as appropriate. The technical features can be deleted as appropriate unless described as essential technical features in the present specification.
(1) According to a first aspect of the present disclosure, a method for manufacturing a three-dimensional shaped object is provided. The manufacturing method includes a first step of forming a shaped object having a cavity by stacking a plurality of layers by discharging a shaping material toward a stage, in which the first step includes a second step of stacking the plurality of layers such that each of the layers includes an overlapping portion in contact with a layer immediately below in a stacking direction and a non-overlapping portion not overlapping the layer immediately below and forming a space below, a top surface having two intersecting inclined surfaces is formed in an upper portion of the cavity by the non-overlapping portion, and a rising angle of each of the two inclined surfaces from a surface parallel to the stage is 35° or more and less than 90°.

According to such an aspect, a portion of the three-dimensional shaped object located above the cavity can be prevented from being deformed due to gravity.
(2) In the aspect described above, the rising angle may be 35° or more and 70° or less.
(3) In the aspect described above, the rising angle may be 35° or more and 55° or less.
(4) In the aspect described above, in the shaped object formed in the first step, the cavity may be tubular, and a portion facing the top surface in the stacking direction may be semicircular. According to such an aspect, the flow path resistance of the cavity can be reduced when the fluid flows in the cavity.
(5) In the aspect described above, each of the layers may include an outermost peripheral region and an inner region in contact with an inside of the outermost peripheral region, and in the second step, each of the layers may be shaped such that an outermost peripheral path for shaping the outermost peripheral region and an inner path for shaping the inner region at least partially overlap. According to such an aspect, separation between the outermost peripheral region and the inner region can be prevented.
(6) In the aspect described above, an overlap amount by which the inner path overlaps the outermost peripheral path may be 10% or more and 50% or less with respect to a line width of the outermost peripheral path. According to such an aspect, separation between the outermost peripheral path and the inner path can be effectively prevented.
(7) In the aspect described above, in the second step, each of the layers may be stacked such that the outermost peripheral path and the inner path overlap in at least a part of the non-overlapping portion. According to such an aspect, separation between the outermost peripheral path and the inner path can be effectively prevented in the non-overlapping portion.
(8) In the aspect described above, the shaping material may contain a metal particle and a thermoplastic resin.

The present disclosure is not limited to the method for manufacturing a three-dimensional shaped object described above, and can be implemented in various aspects such as a three-dimensional shaping device, a computer program, or a non-transitory tangible recording medium in which a computer program is recorded in a computer-readable manner.

What is claimed is:

1. A method for manufacturing a three-dimensional shaped object, the method comprising:
a first step of forming a shaped object having a cavity by stacking a plurality of layers by discharging a shaping material toward a stage, wherein
the first step includes a second step of stacking the plurality of layers such that each of the layers includes an overlapping portion in contact with a layer immediately below in a stacking direction and a non-overlapping portion not overlapping the layer immediately below and forming a space below,
a top surface having two intersecting inclined surfaces is formed in an upper portion of the cavity by the non-overlapping portion, and
a rising angle of each of the two inclined surfaces from a surface parallel to the stage is 35° or more and less than 90°.

2. The method for manufacturing a three-dimensional shaped object according to claim 1, wherein
the rising angle is 35° or more and 70° or less.

3. The method for manufacturing a three-dimensional shaped object according to claim 1, wherein
the rising angle is 35° or more and 55° or less.

4. The method for manufacturing a three-dimensional shaped object according to claim 1, wherein
in the shaped object formed in the first step, the cavity is tubular, and a portion facing the top surface in the stacking direction is semicircular.

5. The method for manufacturing a three-dimensional shaped object according to claim 1, wherein
each of the layers includes an outermost peripheral region and an inner region in contact with an inside of the outermost peripheral region, and
in the second step, each of the layers is shaped such that an outermost peripheral path for shaping the outermost peripheral region and an inner path for shaping the inner region at least partially overlap.

6. The method for manufacturing a three-dimensional shaped object according to claim 5, wherein
an overlap amount by which the inner path overlaps the outermost peripheral path is 10% or more and 50% or less with respect to a line width of the outermost peripheral path.

7. The method for manufacturing a three-dimensional shaped object according to claim 5, wherein
in the second step, each of the layers is stacked such that the outermost peripheral path and the inner path overlap in at least a part of the non-overlapping portion.

8. The method for manufacturing a three-dimensional shaped object according to claim 1, wherein
the shaping material contains a metal particle and a thermoplastic resin.
